(19) United States
(12) Patent Application Publication
(10) Pub. No.: US 2009/0038691 A1
(43) Pub. Date: Feb. 12, 2009

(54) VALVE GUARD ASSEMBLY

(76) Inventors: David William Birch, Hampshire (GB); Andrew Neil Johnson, Berkshire (GB); Mark Adrian Serejko, East Sussex (GB)

Correspondence Address: The BOC Group, Inc., 575 MOUNTAIN AVENUE, MURRAY HILL, NJ, 07974-2082, US

(21) Appl. No.: 12/067,813

(22) PCT Filed: Sep. 13, 2006
(86) PCT No.: PCT/GB2006/050288

§ 371 Date: Jul. 8, 2008

(30) Foreign Application Priority Data
Oct. 28, 2005 (GB) 0522048.8

(51) Int. Cl. F16K 27/08

(52) U.S. Cl. 137/382

(57) ABSTRACT

A valve guard assembly for a gas cylinder has a mounting collar 2 which is adapted to fit around and to engage the neck of the gas cylinder. The mounting collar 2 has an outer surface 6 in which there is an endless first coupling member in the form of a circumferential slot 8. A valve guard 10 has an integral coupling ring 12 with a second coupling member in the form of an endless inward projection 14 engageable with the circumferential slot 8. A means for acting against disengagement of the first and second coupling members is provided. This means takes the form of a locking band 30.

This invention relates to a valve guard assembly for a gas cylinder.

One common method of supplying industrial and other gases is under pressure in a generally cylindrical vessel known as a gas cylinder. The gas cylinder is filled with the gas through a valve in its mouth Instead of just a simple valve through which the cylinder can be filled and gas can be delivered, the cylinder may additionally have a minimum pressure valve which is adapted to prevent the delivery of gas once the pressure inside the cylinder falls to a minimum value or a pressure regulator which enables the user of the cylinder to set the pressure at which gas is delivered, or both these kinds of valve.

Such valves stand proud of the cylinder mouth and are prone to be damaged if the cylinder is dropped or allowed to topple over. It is therefore conventional practice to fit to the neck of the cylinder a device known as a valve guard which protects the cylinder valve or valves from damage by impact. The cylinder guard is clamped directly to the cylinder neck, which is typically screw-threaded, by means of a separate split ring and bolts. The conventional gas cylinder comes in a number of different sizes, particularly neck sizes, and therefore any particular guard can be fitted only to certain cylinders.

It is an aim of the present invention to provide a cylinder guard assembly that ameliorates these difficulties.

According to the present invention there is provided a valve guard assembly for a gas cylinder, comprising a mounting collar which is adapted to fit around and to engage the neck of the gas cylinder and which has an outer surface including at least one first coupling member; a valve guard having an integral coupling ring which has at least one second coupling member engageable with the said first coupling member; and means for acting against disengagement of the first and second coupling members.

The use of the mounting collar takes away the disadvantage of having to employ a fastening which is required both to hold the valve guard together and to secure it to the neck of the gas cylinder. Further, a range of different mounting collars may be used to adapt a single valve guard to a number of different cylinder neck sizes.

The means for acting against disengagement of the first and second coupling members preferably takes the form of a first locking band able to be tightened circumferentially around the coupling ring. The first locking band is particularly effective at preventing the valve guard from working loose. The first locking band may be a plastics member or may be formed of a metal. If of metal, the first locking band may take the form of a worm drive clip or a C-ring. It is nonetheless within the scope of the invention simply to employ a plurality of bolts to fasten the coupling ring to the mounting collar.

The first and second coupling members are preferably adapted to make an interference fit with one another. The first and second coupling members are preferably both endless.

Typically, one of the first and second coupling members is in the form of a projection of cuneiform cross-section, tapering to a distal face, and the other of the first and second coupling members is a complementary slot. It is typically the second coupling member that is in the form of the projection of cuneiform cross-section, and the first coupling member that is the complementary slot.

Preferably, one or both of the first and second coupling members have raised but deformable surface elements which may, for example, take the form of flutes, splines or knurls. The deformable surface elements help to enhance the engagement between the first and second coupling members.

The coupling ring of the valve guard preferably has an endless circumferential groove of a configuration matching that of the first locking band so that it is able to receive such band.

The inner surface of the mounting ring preferably has screw threads complementary to those on the neck of the cylinder.

The valve guard preferably comprises a plurality of pieces or parts. The pieces preferably engage one another in a plane normal to that of the mounting collar. The valve guard may therefore have two pieces which are held together by suitable bolts or screws. Alternatively, the two pieces may be held in engagement by a second locking band which may be similar to the first locking band and which is therefore able to be tightened circumferentially around the two pieces and which is preferably seated in a second endless circumferential groove formed in the valve guard. In another alternative, the valve guard can be made as a unitary article.

A cylinder valve guard assembly according to the invention will now be described by way of example with reference to the accompanying drawings, in which:

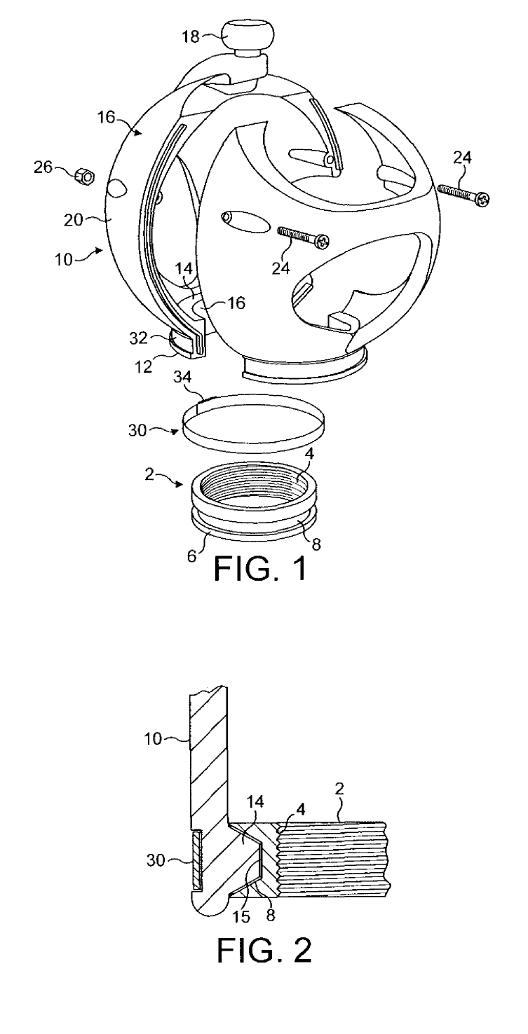

FIG. 1 is a schematic exploded perspective view of the cylinder valve guard assembly;

FIG. 2 is a radial section through the assembly;

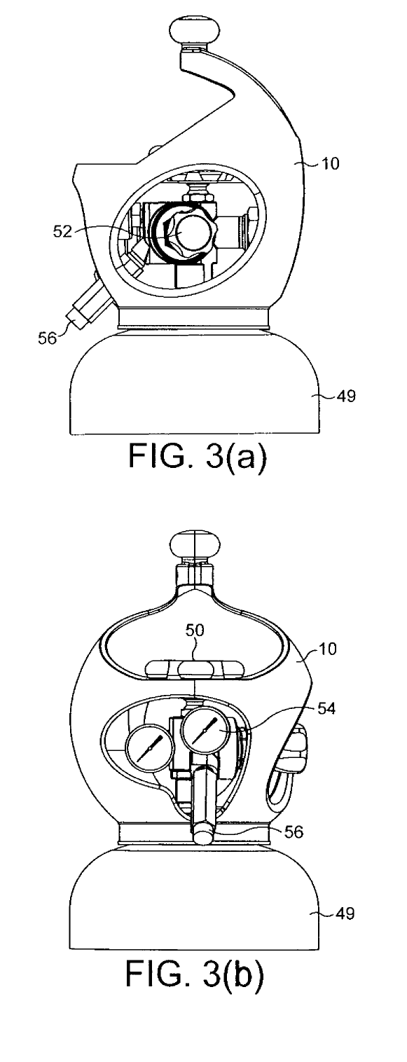

FIG. 3(a) is a side view showing the cylinder valve guard assembly fitted to a gas cylinder;

FIG. 3(b) is a front view showing the cylinder valve guard assembly fitted to a gas cylinder; and

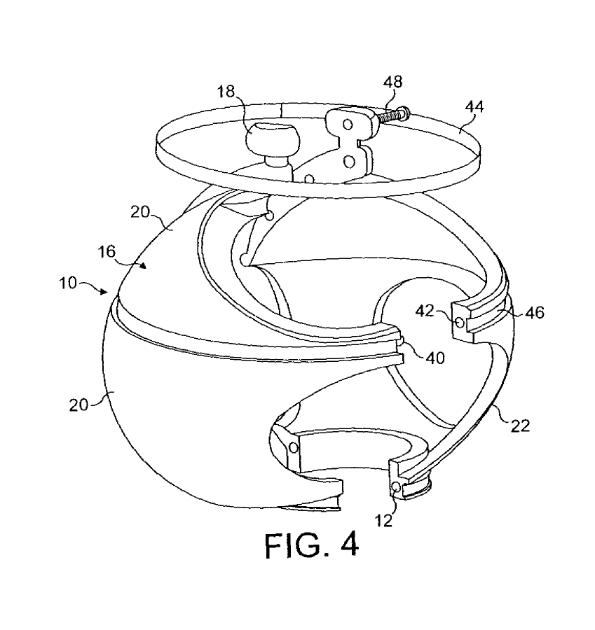

FIG. 4 is a schematic exploded perspective view of part of an alternative cylinder valve guard assembly to that shown in FIGS. 1 to 3.

Like parts in the drawings are indicated by the same reference numerals.

Referring to FIGS. 1 to 3 of the drawings, the cylinder valve guard assembly comprises a mounting collar 2 which is adapted to fit around and to engage the neck of a gas cylinder 49 (not shown in FIGS. 1 and 2). The mounting collar 2 has an inner surface which has screw-threads 4 complementary to those on the neck of the gas cylinder 49 (not shown in FIGS. 1 and 2). The mounting collar 2 can thus be tightened into position on the cylinder such that it does not come loose or rotate during operation. If desired, a suitable thread-locking compound may be applied to the screw threads 4 so as to enhance the engagement between the mounting collar 2 and the neck of the gas cylinder.

The mounting collar 2 has an external surface 6 in which there is an endless first coupling member in the form of a circumferential slot 8. As will be described below, the circumferential slot 8 makes an interference fit with a complementary second coupling member forming part of a valve guard 10.

The valve guard 10 has an integral coupling ring 12 at its bottom. It is this coupling ring 12 which engages the mounting collar 2. The inner surface of the coupling ring 12 has a coupling member in the form of an endless inward circumferential projection 14 which, as shown in FIG. 2, is of cuneiform cross-section, tapering to a distal face 15. The endless slot 8 in the mounting collar 2 has a complementary taper. When fitting the valve guard 10 to the mounting collar 2, the projection 14 may simply be pushed into the slot 8. The material from which the valve guard 10 is made preferably has a natural resilience which facilitates engagement between the projection 14 and the slot 8 and resists retraction of the projection. In order to enhance the engagement the projection 14 may have integral deformable surface elements (not shown) such as flutes, splines or knurls (not shown).

As shown in the drawings, both the slot 8 and the projection 14 are endless. It is possible, in an alternative arrangement, for a circumferential array of arcuate projections and a complementary array of slots to be used instead. Such an arrangement makes assembly more difficult and is therefore not preferred. Further, when mounting the valve guard 10 on the mounting collar 2, it is not necessary at first to choose a precise juxtaposition of the guard 10 and the cylinder shut-off valve 50 (not shown in FIGS. 1 and 2) because the guard 10 may be freely rotated relative to the mounting collar 2.

The valve guard 10 has a configuration such that it can fulfil two main functions, one of which is to protect the valve from damage if the cylinder is dropped or is allowed to topple over and the other of which is to allow access to the valve 50 (not shown in FIGS. 1 and 2). The shape and configuration of the valve guard need not be dictated solely by function and may be selected according to aesthetic criteria. The valve guard 10 that is shown in the drawings has a generally hollow spherical body or shell 16 formed with large access openings to permit manual operation of shut-off valve 50, pressure adjustment knob 52, and through which the face of any pressure gauge 54 can be clearly observed. As illustrated in FIGS. 3(a) and 3(b), these access openings also enable a gas outlet 56 to protrude from the valve guard 10. If desired, as shown in FIGS. 1 and 3, the body 16 may have an integral handle 18 at its top.

The shape and configuration of the body 16 of the valve guard 10 are such as to protect the cylinder valve 50 and knob 52 if the cylinder is dropped on its head or if the cylinder head suffers a side impact as might happen if the cylinder is allowed to topple over. A large number of alternative configurations of valve guard 10 are, however, possible. For example, there may simply be a plurality of posts (not shown) integral with the coupling ring 12 and positioned relative to one another so as to absorb normal impacts from the side, but spaced sufficiently apart to permit manual access to the cylinder valve. Further, there may be at least one bridge piece (not shown) integral with at least two of the posts so to protect the valve if the cylinder is dropped on its head. In yet another alternative (also not shown) there is no such bridge or overhead piece but the posts or sides of the guard extend well above the cylinder valve such that if the cylinder is dropped on its head these posts or sides are able to take the impact.

Although the valve guard 10 may be made as a unitary article which can be pushed into position over the mounting collar 2, as shown in FIG. 1, it is preferably formed of two pieces or parts 20 and 22, being split vertically. The two pieces 20 and 22 are preferably secured together by a pair of horizontally disposed bolts 24 which are both provided with matching nuts 26 (only one of which is shown in FIG. 1). The vertical axis of the valve guard 10 lies in the plane of the split. The handle 18 is positioned off-centre so that it is not split.

The valve assembly according to the invention also includes a locking band 30 which is able to be fitted around the coupling ring 12 at the bottom of the valve guard 10, the locking band 30 being received in a complementary circumferential endless groove 32 formed in the external surface of the ring 12. The locking band 30 takes the form of a strip having a clasp 34 at one end which is adapted to receive and lock the other end as the band is tightened about the circumference of the coupling ring 12. In one arrangement the clasp 34 is a loop or catch. The other end of the locking band is formed as a tongue carrying an integral wedge-shaped projection (not shown) having its thinner end nearer than its wider end to the tip of the tongue. The natural resilience of the projection enables it to be momentarily deformed as the tongue is pushed through the loop or catch. Once the tongue has been inserted, an attempt to retract it would fail because the thicker end of the wedge would be stopped by the top of the loop or catch. Thus the tongue is locked in the loop or catch. Alternatively, the locking band can be tightened around the coupling ring 12 and its ends crimped together using a suitable tool.

Tightening of the locking band 30 exerts a force on the projection 14 which resists its retraction from the slot 8. Further, tightening of the locking band 30 prevents rotation of the valve guard 10 relative to the mounting collar 2. Thus, when assembling the valve guard on the neck of a gas cylinder the two separate pieces or parts 20 and 22 of the valve guard may be engaged with the mounting collar such that the access openings in the spherical body 16 have no predetermined orientation relative to the valve. The two parts 20 and 22 are then bolted together. After that, the valve guard 10 is rotated on the mounting collar 2 until it comes to a desired orientation relative to the cylinder valve. The locking band is then fitted around the coupling ring 12 in the groove 32 and tightened. Because the locking band 30 cannot be undone without destroying it and because the mounting collar 2 can be firmly held in position on the cylinder neck by its screw threads the valve guard assembly cannot easily be disassembled by a user of the gas cylinder.

The valve guard 10 is preferably made of a high density plastics material which has some inherent resilience. Suitable plastics materials include, for example, nylon. Alternatively, a metal or alloy preferably with some inherent resilience may be used instead. For example, the valve guard may be made of a lightweight alloy such as an aluminium alloy. The mounting collar 2 may be made of either plastics material or of metal. Preferred materials for the fabrication of the mounting collar 2 are stainless steel and aluminium. The locking band 30 is typically made of a plastics material such as nylon. Alternatively it can be made of a steel, for example, a stainless steel.

The valve guard 10 can be accommodated on a range of cylinders having different neck sizes by the use of different appropriately dimensioned mounting collars 2.

If desired, the internal or even the external surfaces of the spherical body 16 of the valve guard 10 may be provided with ribbing (not shown) or similar members so as to strengthen it.

An alternative form of the valve guard is shown in FIG. 4. Instead of employing the bolts 24 to secure together the two pieces of the body or shell 16 of the valve guard 10, the piece 20, which is generally hemispherical, is formed with two generally diametrically opposite integral prongs 40 (only the end of one prong 40 being visible in FIG. 4) which engage complementary sockets 42 in the other hemispherical piece 22 (only one socket 42 being visible in FIG. 4.) Disengagement of the prongs 40 from the sockets 42 is prevented by a second locking band 44 which may be of analogous configuration and operation to the locking band 30 shown in FIG. 1. The second locking band 44 may be seated in a second circumferential groove 46 formed in the body 16 of the valve guard.

In the valve guard shown in FIG. 4 the handle 18 is located on the vertical axis of the body 16. Accordingly it is split. The two parts of the handle 18 are secured together by means of a screw 48.

1. A valve guard assembly for a gas cylinder, comprising a mounting collar which is adapted to fit around and to engage the neck of the gas cylinder and which has an outer surface including at least one first coupling member; a valve guard having an integral coupling ring which has at least one second coupling member engageable with the said first coupling member; and a means for acting against disengagement of the first and second coupling members.

2. The valve guard assembly as claimed in claim 1, in which the said means for acting against disengagement of the first and second coupling members is a first locking band able to be tightened circumferentially around the coupling ring.

3. The valve guard assembly as claimed in claim 1, wherein the first and second coupling members are adapted to make an interference fit with one another.

4. The valve guard assembly as claimed in claim 1, wherein one of the first and second coupling members is in the form of a projection of cuneiform cross-section, tapering to a distal face, and the other of the first and second coupling members is a complementary slot.

5. The valve guard assembly as claimed in claim 4, wherein the second coupling member is in the form of the projection of cuneiform cross-section, and the first coupling member is the complementary slot.

6. The valve guard assembly as claimed in claim 4, wherein the first and second coupling members are both endless.

7. The valve guard assembly as claimed in claim 1, wherein one or both of the first and second coupling members have raised but deformable surface elements.

8. The valve guard assembly as claimed in claim 1, wherein the coupling ring of the valve guard has a first endless circumferential groove of a configuration matching that of the locking band.

9. The valve guard assembly as claimed in claim 1, wherein the inner surface of the mounting ring has screw threads.

10. The valve guard assembly as claimed in claim 1, wherein the valve guard is a unitary article.

11. The valve guard assembly as claimed in claim 1, wherein the valve guard comprises a plurality of pieces.

12. The valve guard assembly as claimed in claim 10, wherein the valve guard comprises two pieces that engage one another in a plane normal to that of the mounting collar.

13. The valve guard assembly as claimed in claim 12, additionally including a second locking band which is able to be tightened around the two pieces so as to hold them in engagement.

14. The valve guard assembly as claimed in claim 13, wherein the second locking band is seated in a second endless circumferential groove formed in the valve guard.
